(19) United States
(12) Patent Application Publication
(10) Pub. No.: US 2024/0121697 A1
(43) Pub. Date: Apr. 11, 2024

(54) SYSTEMS AND METHODS FOR MAINTAINING INTERNET PROTOCOL ADDRESS DURING AND AFTER FAILOVER

(71) Applicant: DataRemote, Inc., Miami, FL (US)

(72) Inventors: Briam RODRIGUEZ, Miami, FL (US); Antonio SERRANO, Miami, FL (US)

(21) Appl. No.: 17/960,918

(22) Filed: Oct. 6, 2022

(51) Int. Cl. H04W 40/04; H04W 16/10

(52) U.S. Cl. CPC H04W 40/04; H04W 16/10

(57) ABSTRACT

An apparatus for internet protocol (IP) address continuity includes a network port configured for Internet communications and communicatively coupled to an Internet gateway device including a first IP address; an integrated cellular modem configured for Internet communications, the integrated cellular modem including a second IP address; a local area network port; a switch configured for selectively switching between a first mode where the internet communications are via the network port and a second mode where the internet communications are via the integrated cellular modem; a processor; and a memory. The memory stores instructions, which, when executed by the processor, cause the apparatus to: determine network connectivity of the Internet gateway device; selectively switch to the second mode from the first mode based on the network connectivity; receive a second signal via the integrated cellular modem; and pass the first IP address to the local area network port.

### TECHNICAL FIELD

The present application relates to internet gateways and, in particular, to an apparatus for maintaining an internet protocol (IP) address during and after a failover.

### BACKGROUND

As users are relying on increasing amounts of data connectivity, there are demands to have such data connectivity always available, even in the face of wide area network failure or power failure. In the event that a connection issue arises, electronic devices will account for the issue by establishing a new connection, but the establishment of this new connection will lead to the terminal being detected as a wholly different network address than was initially used. Accordingly, there is interest in improvement via redundant systems.

### SUMMARY

This disclosure relates to internet gateways and, in particular, to an apparatus for maintaining an internet protocol (IP) address during and after a failover.

In accordance with aspects of the present disclosure, an apparatus for IP address continuity includes a network port configured for Internet communications and communicatively coupled to an Internet gateway device; an integrated cellular modem configured for Internet communications; a second network port configured for connecting to a local area network; a switch configured for selectively switching between a first mode where the internet communications are via the network port and a second mode where the internet communications are via the integrated cellular modem; a processor; and a memory. The Internet gateway device includes a first IP address. The integrated cellular modem includes a second IP address different from the first IP address. The memory is coupled to the processor and stores instructions, which, when executed by the processor, cause the apparatus to: determine the first IP address of the Internet gateway device; determine network connectivity of the Internet gateway device connected to the network port; selectively switch the switch to the second mode from the first mode based on the network connectivity; receive a second signal via the integrated cellular modem; and pass the first IP address to the second network port.

In an aspect of the present disclosure, the second signal may include one or more packets. The one or more packets may include the second IP address of the integrated cellular modem.

In an aspect of the present disclosure, the instructions, when executed by the processor, may further cause the apparatus to reconfigure the one or more packets to replace the second IP address with the first IP address in a header of the one or more packets, for transmission to the second network port.

In another aspect of the present disclosure, the instructions, when executed by the processor, may further cause the apparatus to perform a many-to-one mapping of at least one of a private IP address or a subnet inside the local area network to the first IP address.

In yet another aspect of the present disclosure, determining the network connectivity may include determining whether a presence and/or a quality of a signal is below a predetermined threshold.

In a further aspect of the present disclosure, the second IP address may be assigned by an internet service provider.

In yet a further aspect of the present disclosure, the first IP address may be assigned by an internet service provider.

In an aspect of the present disclosure, the network port may be connected to cable, digital subscriber line, and/or fiber.

In another aspect of the present disclosure, the instructions, when executed by the processor, may further cause the apparatus to replace a second header of a second IP packet that includes the second IP address with a first header that includes the first IP address.

In accordance with aspects of the present disclosure, a computer-implemented method for IP address continuity is presented. The method includes determining a first IP address of an Internet gateway device communicatively coupled to a network port of an apparatus, the Internet gateway device including the first IP address; determining network connectivity of the Internet gateway device connected to the network port; and selectively switching a switch of the apparatus to a second mode from a first mode based on the network connectivity. The switch is configured for selectively switching between the first mode where the internet communications is via the network port and the second mode where the internet communications is via an integrated cellular modem of the apparatus. The method further includes receiving a second signal via the integrated cellular modem and passing the first IP address to a second network port of the apparatus. The second network port is configured for connecting to a local area network.

In yet another aspect of the present disclosure, the second signal may include one or more packets, the one or more packets including the second IP address of the integrated cellular modem.

In a further aspect of the present disclosure, the method may further include reconfiguring the one or more packets to replace the second IP address with the first IP address in a header of the one or more packets for transmission to the second network port.

In yet a further aspect of the present disclosure, the method may further include performing a many-to-one mapping of at least one of a private IP address or a subnet inside local area network to the first IP address.

In an aspect of the present disclosure, determining the network connectivity includes determining whether a presence and/or a quality of a signal is below a predetermined threshold.

In yet another aspect of the present disclosure, the second IP address may be assigned by an internet service provider.

In a further aspect of the present disclosure, the first IP address may be assigned by an internet service provider.

In yet a further aspect of the present disclosure, the network port may be connected to cable, digital subscriber line, and/or fiber.

In an aspect of the present disclosure, the method may further include electrically coupling a power output connector of the apparatus to the Internet gateway device and providing power to the Internet gateway device.

In accordance with aspects of the present disclosure, a non-transitory computer-readable storage medium in which is stored instructions for causing a processor to execute a computer-implemented method for internet protocol address continuity is presented. The method includes: determining a first IP address of an Internet gateway device communicatively coupled to a network port of an apparatus, the Internet gateway device includes the first IP address; determining network connectivity of the Internet gateway device connected to the network port; selectively switching a switch of the apparatus to a second mode from a first mode based on the network connectivity; receiving a second signal via the integrated cellular modem; and passing the first IP address to a second network port of the apparatus. The second network port is configured for connecting to a local area network. The switch is configured for selectively switching between the first mode where the internet communications are via the network port and the second mode where the internet communications are via an integrated cellular modem of the apparatus.

In an aspect of the present disclosure, the method may further include performing a many-to-one mapping of at least one of a private IP address or a subnet inside the local area network to the first IP address.

Further details and aspects of exemplary embodiments of the present disclosure are described in more detail below with reference to the appended figures.

### BRIEF DESCRIPTION OF THE DRAWINGS

A better understanding of the features and advantages of the disclosed technology will be obtained by reference to the following detailed description that sets forth illustrative embodiments, in which the principles of the technology are utilized, and the accompanying drawings of which:

FIG. 1 is a diagram illustrating a networked environment for operating an apparatus for internet protocol address continuity during and after a failover, in accordance with aspects of the present disclosure;

FIG. 2 is a diagram illustrating the apparatus of FIG. 1 operating in a failover state, in accordance with aspects of the present disclosure;

FIG. 3 is a rear view of the apparatus of FIG. 1, in accordance with aspects of the present disclosure;

FIG. 4 is a block diagram of a controller of the apparatus of FIG. 1, in accordance with aspects of the present disclosure;

FIG. 5 is a block diagram of the apparatus of FIG. 1, in accordance with aspects of the present disclosure;

FIG. 6 is a flow diagram of an exemplary method for using the networked environment of FIG. 1, in accordance with aspects of the present disclosure; and

FIG. 7 is a diagram of an exemplary network packet, in accordance with aspects of the present disclosure.

### DETAILED DESCRIPTION

The present application relates to internet gateways and, in particular, to an apparatus for maintaining an IP address during and after a failover.

For purposes of promoting an understanding of the principles of the present disclosure, reference will now be made to exemplary embodiments illustrated in the drawings, and specific language will be used to describe the same. It will nevertheless be understood that no limitation of the scope of the present disclosure is thereby intended. Various alterations, rearrangements, substitutions, and modifications of the inventive features illustrated herein, and any additional applications of the principles of the present disclosure as illustrated herein, which would occur to one skilled in the relevant art and having possession of this disclosure, are to be considered within the scope of the present disclosure.

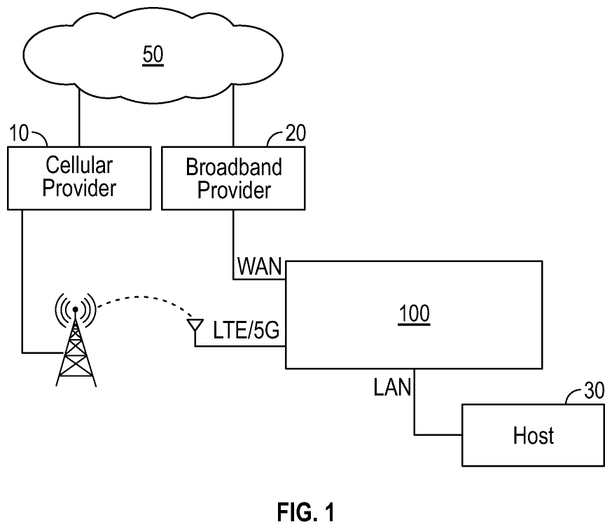

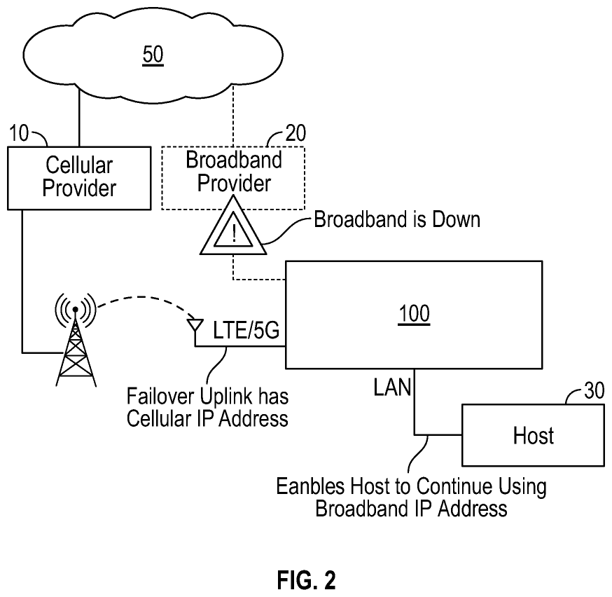

Referring to FIGS. 1 and 2, an exemplary apparatus 100 for internet protocol address continuity during and after a failover in accordance with aspects of the present disclosure is shown. The apparatus 100 is configured to maintain a static IP address during and after a failover (FIG. 2) from a broadband provider 20 to a cellular provider 10 (e.g., LTE/5G). The disclosed technology has the benefit of providing dynamic network address translation. The disclosed technology has the further benefit of not merely passing an IP address assigned from the broadband provider (e.g., internet service provider) to the attached downstream device(s) but swapping out the IP address assigned by an internet service provider (ISP) to an integrated cellular modem with the IP address assigned by an internet service provider to another device, such as an internet gateway device.

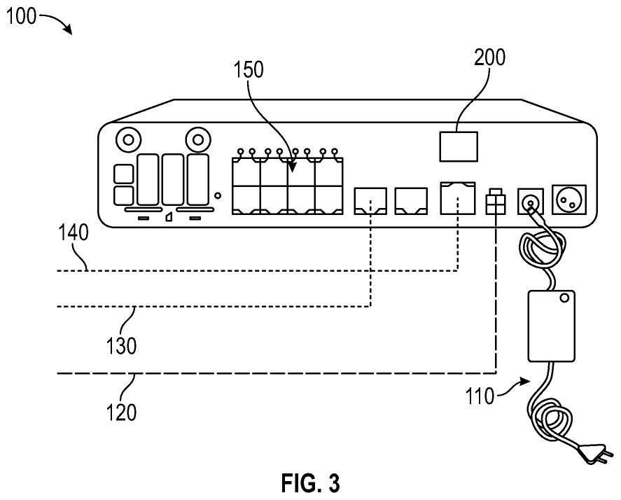

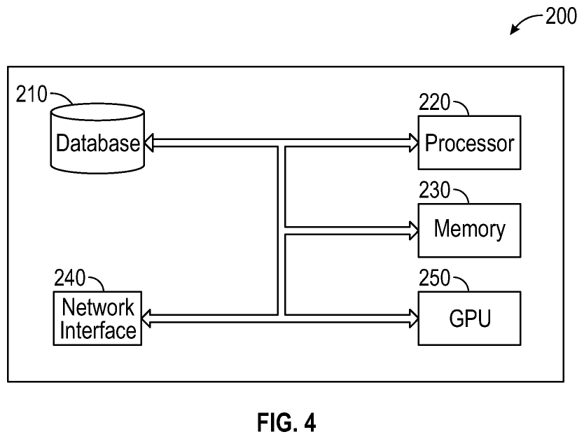

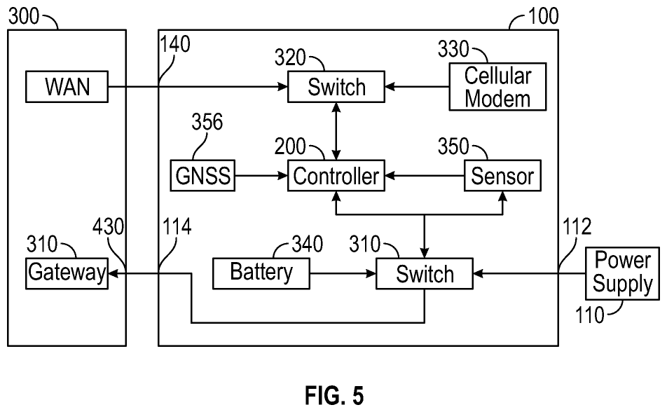

With reference to FIGS. 3 and 5, the apparatus 100 generally includes a power source 110 configured for powering the apparatus 100, an integrated battery 160 configured for providing backup power to the apparatus 100, a power output jack 114, a first switch 310, a sensor 350, a network port 140, such as, for example, a Wide Area Network (WAN) port, an integrated cellular modem 330 configured for Internet communications, a second switch 320, a second network port 130, and a controller 200 (FIG. 4).

In aspects, the power source 110 may be an external power supply connected to the apparatus 100 via a power input jack 112.

The first switch 310 (FIG. 5) is configured for selectively switching from a first mode where the power source supplies power to the apparatus 100 and a second mode where the integrated battery 160 supplies power to the apparatus 100.

The sensor 350 is configured to detect a first signal indicating a presence of power from the power source 110. The sensor 350 is communicatively coupled to the controller 200.

The network port 140 is configured for Internet communications and communicatively coupled to an Internet gateway device 300. In aspects, the primary internet source may be located in the internet gateway device 300, and not the apparatus 100. In aspects, switching between the primary source and the backup source may at least partially occur within the internet gateway device 300. The internet gateway 300 may include a power input port 430, which is configured to be connected to a power supply, such as power output jack 114.

The second network port 130 is configured for connecting to a local area network (LAN). The second network port 130 enables devices connected to the LAN to communicate with the Internet.

The second switch 320 (FIG. 5) is configured for selectively switching between a third mode where the internet communications is via the network port 140 and a fourth mode where the internet communications is via the integrated cellular modem 330. The second switch 320 enables automatic failover. The controller 200 (FIG. 4) is responsible for detecting the degradation of quality in network connectivity (e.g., low bandwidth, high latency/jitter, no Internet connectivity, etc.) and for automatically switching over to the integrated cellular modem 330 to maintain network connectivity. The apparatus 100 may further include one or more Foreign Exchange Station (FXS) ports 150 configured for Plain Old Telephone System (POTS) line replacement.

The apparatus 100 may further include a Global Positioning Satellite (GPS) receiver 356 configured to monitor geographical location information of the apparatus 100. In aspects, when the FXS ports are being used to provide POTS replacement lines, the controller 200 (FIG. 4) may monitor the geographical location of the apparatus 100 using the GPS receiver 356 and electronically provide the monitored geographical location information of the apparatus 100 when requested by emergency responders.

Referring now to FIG. 4, exemplary components in the controller 200 in accordance with aspects of the present disclosure include, for example, a database 210, one or more processors 220, at least one memory 230, and a network interface 240.

The database 210 can be located in storage. The term “storage” may refer to any device or material from which information may be capable of being accessed, reproduced, and/or held in an electromagnetic or optical form for access by a computer processor. Storage may be, for example, volatile memory such as RAM, non-volatile memory, which permanently hold digital data until purposely erased, such as flash memory, magnetic devices such as hard disk drives, and optical media such as a CD, DVD, Blu-ray disc, or the like.

As described in more detail herein below, the processor 220 executes various processes based on instructions that can be stored in the server memory 230 and utilizes the data from the database 210.

Referring to FIG. 5, the apparatus 100 is shown connected to an internet gateway device 300. The internet gateway device 300 is configured to connect from a network, such as an Internet Service Provider, and route the WAN to the local devices, such as local computers.

The apparatus 100 may further include a power output connector 114 configured to electrically couple to the Internet gateway device 300 and provide power to the Internet gateway device 300. In aspects, network may include cable, digital subscriber line, and/or fiber.

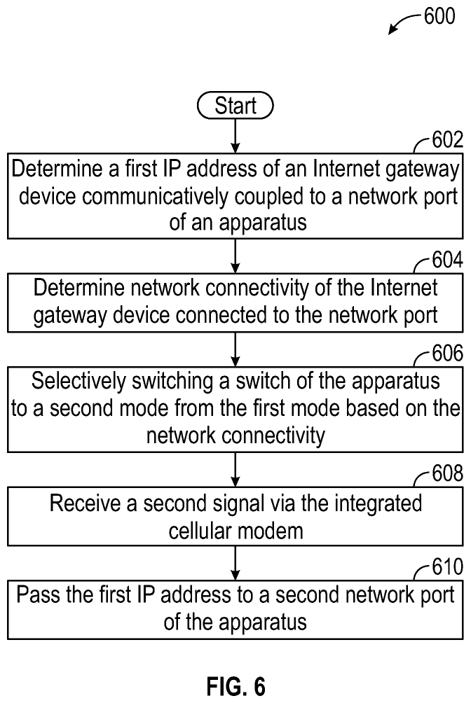

FIG. 6 shows a block diagram for an exemplary method for operating an apparatus for IP address continuity, in accordance with aspects of the present disclosure. Although the steps of FIG. 6 are shown in a particular order, the steps need not all be performed in the specified order. However, in various aspects, the operations of FIG. 6 may be performed all or in part by the controller 200 of FIG. 4. In aspects, the operations of FIG. 6 may be performed all or in part by another device, for example, a mobile device and/or a client computer system. These variations are contemplated to be within the scope of the present disclosure.

Initially, at step 502 the controller 200 determines a first IP address of an Internet gateway device 300 communicatively coupled to a network port 140 of an apparatus 100. For example, the Internet gateway device 300 may assigned the first IP address (source IP address 712) from a broadband provider 20 (FIG. 1). The first IP address may be stored in a database or in the memory of the apparatus 100.

Next at block 504, the controller 200 determines network connectivity of the Internet gateway device connected to the network port 140. For example, the controller 200 may determine whether a presence and/or a quality of a second signal on the network port 140 is below a predetermined threshold. The apparatus 100 enables automatic failover to an integrated cellular modem 330 for when the network port 140 has poor signal or no signal (FIG. 2). For example, if an Internet service provider connected to network port 140 has a failure, the apparatus 100 detects the failure and enables automatic failover to the integrated cellular modem 330.

Next, at block 506, the controller 200 selectively switches a switch 320 (FIG. 5) of the apparatus 100 to a second mode from the first mode based on the network connectivity. The switch 320 is configured for selectively switching between a first mode where the internet communications is via the network port 140 and the second mode where the internet communications is via an integrated cellular modem 330 of the apparatus. In aspects, the cellular modem 330 may be integrated into the apparatus 100, or it may be external to the apparatus 100.

In aspects, the controller 200 may monitor the geographical location of the apparatus using the GPS receiver 356 (FIG. 1), and electronically provide the monitored geographical location information of the apparatus 100 when requested by emergency responders (e.g., an emergency telephone number such as 911).

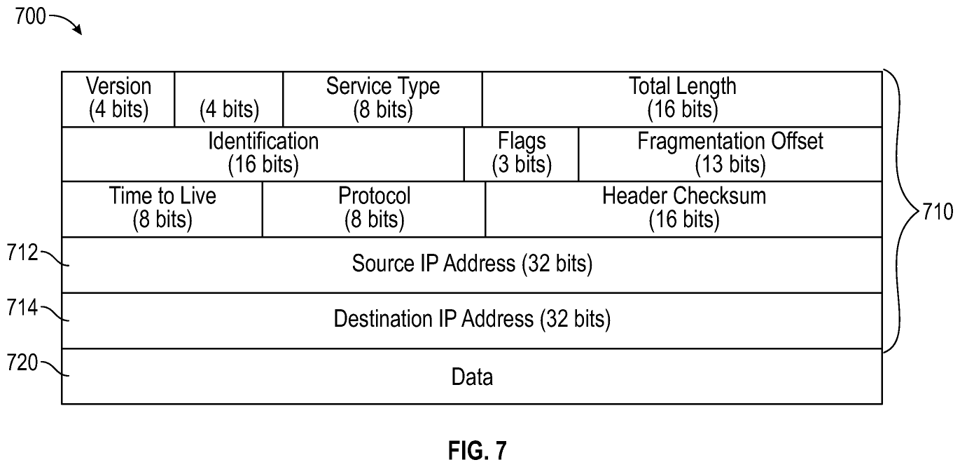

Next, at block 508, during failover, the controller 200 receives a second signal via the integrated cellular modem 330. The second signal includes a network packet 700 (FIG. 7) that includes a second IP address (a second source IP address 712) assigned by the cellular provider 10 (FIG. 1). The second IP address is different than the first IP address. The first IP address may include the source IP address at the datalink (layer 2) level of the network packet 700.

The second signal may include one or more packets that each include the second IP address (e.g., the IP address of the integrated cellular modem).

A network packet 700 is the fundamental unit of information transmitted over a network or over a digital communication link. Network packets 700, for example, may contain a header 710 and a payload 720 (e.g., data). The header 710 may include control information about the packet type, source IP address 712, and/or destination IP address 714 (FIG. 7).

Next, at block 510, the controller 200 passes the first IP address to a second network port 130 of the apparatus 100. For example, in the event of a failure of the primary connection (e.g., the broadband connection) when the apparatus 100 switches over to a cellular connection (e.g., by the integrated cellular modem 330), the device(s) connected to the second network port 130 (e.g., a local area network (LAN) port) of the apparatus 100 see the same static IP address (i.e., the IP address assigned to the broadband connection by the ISP).

In aspects, the controller 200 may perform a many-to-one mapping of a private IP address and/or subnet inside the local area network to the first IP address.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein described methods, programs, algorithms, or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages that are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

It should be understood the foregoing description is only illustrative of the present disclosure. Various alternatives and modifications can be devised by those skilled in the art without departing from the present disclosure. Accordingly, the present disclosure is intended to embrace all such alternatives, modifications, and variances. The embodiments described with reference to the attached drawing figures are presented only to demonstrate certain examples of the present disclosure. Other elements, steps, methods, and techniques that are insubstantially different from those described above are also intended to be within the scope of the present disclosure.

What is claimed is:

1. An apparatus for internet protocol (IP) address continuity, said apparatus comprising:
a network port configured for Internet communications and communicatively coupled to an Internet gateway device, the Internet gateway device including a first IP address;
an integrated cellular modem configured for Internet communications, the integrated cellular modem including a second IP address different from the first IP address;
a second network port configured for connecting to a local area network;
a switch configured for selectively switching between a first mode where the internet communications are via the network port and a second mode where the internet communications are via the integrated cellular modem;
a processor; and
a memory coupled to the processor and storing instructions, which, when executed by the processor, the apparatus to:
determine the first IP address of the Internet gateway device;
determine network connectivity of the Internet gateway device connected to the network port;
selectively switch the switch to the second mode from the first mode based on the network connectivity;
receive a second signal via the integrated cellular modem; and
pass the first IP address to the second network port.

2. The apparatus of claim 1, wherein the second signal includes one or more packets, the one or more packets including the second IP address of the integrated cellular modem.

3. The apparatus of claim 2, wherein the instructions, when executed by the processor, further cause the apparatus to:
reconfigure the one or more packets to replace the second IP address with the first IP address in a header of the one or more packets, for transmission to the second network port.

4. The apparatus of claim 1, wherein the instructions, when executed by the processor, further cause the apparatus to:
perform a many-to-one mapping of at least one of a private IP address or a subnet inside the local area network to the first IP address.

5. The apparatus of claim 1, wherein determining the network connectivity includes determining whether at least one of a presence or a quality of a signal is below a predetermined threshold.

6. The apparatus of claim 1, wherein the second IP address is assigned by an internet service provider.

7. The apparatus of claim 1, wherein the first IP address is assigned by an internet service provider.

8. The apparatus of claim 1, wherein the network port is connected to at least one of cable, digital subscriber line, or fiber.

9. The apparatus of claim 1, wherein the instructions, when executed by the processor, further cause the apparatus to:
replace a second header of a packet that includes the second IP address with a first header that includes the first IP address.

10. A computer-implemented method for internet protocol address continuity, the method comprising:
determining a first IP address of an Internet gateway device communicatively coupled to a network port of an apparatus, Internet gateway device including the first IP address;
determining network connectivity of the Internet gateway device connected to the network port;
selectively switching a switch of the apparatus to a second mode from a first mode based on the network connectivity, wherein the switch is configured for selectively switching between the first mode where the internet communications is via the network port and a second mode where the internet communications is via an integrated cellular modem of the apparatus;
receiving a second signal via the integrated cellular modem; and
passing the first IP address to a second network port of the apparatus, wherein the second network port is configured for connecting to a local area network.

11. The computer-implemented of claim 10, wherein the second signal includes one or more packets, the one or more packets including the second IP address of the integrated cellular modem.

12. The computer-implemented of claim 11, further comprising:
reconfiguring the one or more packets to replace the second IP address with the first IP address in a header of the one or more packets, for transmission to the second network port.

13. The computer-implemented of claim 10, further comprising:
performing a many-to-one mapping of at least one of a private IP address or a subnet inside the local area network to the first IP address.

14. The computer-implemented of claim 10, wherein determining the network connectivity includes determining whether at least one of a presence or a quality of a signal is below a predetermined threshold.

15. The computer-implemented of claim 10, wherein the second IP address is assigned by an internet service provider.

16. The computer-implemented of claim 10, wherein the first IP address is assigned by an internet service provider.

17. The computer-implemented of claim 10, wherein the network port is connected to at least one of cable, digital subscriber line, or fiber.

18. The computer-implemented of claim 10, further comprising:
electrically coupling a power output connector of the apparatus to the Internet gateway device; and
providing power to the Internet gateway device.

19. A non-transitory computer-readable storage medium in which is stored instructions for causing a processor to execute a computer-implemented method for internet protocol address continuity, the method comprising:
determining a first IP address of an Internet gateway device communicatively coupled to a network port of an apparatus, Internet gateway device including the first IP address;
determining network connectivity of the Internet gateway device connected to the network port;
selectively switching a switch of the apparatus to a second mode from a first mode based on the network connectivity, wherein the switch is configured for selectively switching between the first mode where the internet communications is via the network port and the second mode where the internet communications is via an integrated cellular modem of the apparatus;
receiving a second signal via the integrated cellular modem; and
passing the first IP address to a second network port of the apparatus, wherein the second network port is configured for connecting to a local area network.

20. The non-transitory computer-readable storage medium of claim 19, wherein the method further comprises:
performing a many-to-one mapping of at least one of a private IP address or subnet inside the local area network to the first IP address.
